(19) United States
(12) Patent Application Publication
(10) Pub. No.: US 2026/0130439 A1
(43) Pub. Date: May 14, 2026

(54) AEROSOL GENERATING DEVICE

(71) Applicant: KT&G CORPORATION, Daejeon (KR)

(72) Inventors: Sangcheol PARK, Daejeon (KR); Jungho Kim, Daejeon (KR); Jangwon Seo, Daejeon (KR); Wonkyeong Lee, Daejeon (KR); Chulho Jang, Daejeon (KR); Jinchul Jung, Daejeon (KR)

(73) Assignee: KT&G CORPORATION, Daejeon (KR)

(21) Appl. No.: 19/338,189

(22) Filed: Sep. 24, 2025

(30) Foreign Application Priority Data
Nov. 14, 2024 (KR) 10-2024-0162274
Mar. 14, 2025 (KR) 10-2025-0033597

(51) Int. Cl. A24F 40/57; A24F 40/46; A24F 40/53; A24F 40/60; H05B 6/68; H05B 6/80

(52) U.S. Cl. CPC A24F 40/57; A24F 40/46; A24F 40/53; A24F 40/60; H05B 6/68; H05B 6/80; H05B 2206/04

(57) ABSTRACT

An aerosol generating device includes a housing including an accommodation space, a battery, a source unit configured to generate electromagnetic waves based on power supplied from the battery, a first conductive member configured to radiate the electromagnetic waves generated in the source unit towards the aerosol generating article to heat the aerosol generating article, a second conductive member configured to generate heat when power is supplied from the battery to heat the aerosol generating article, and a processor operatively connected to the battery, wherein the processor is configured to control the battery to supply power to one of the source unit and the second conductive member, based on a type of the aerosol generating article accommodated in the accommodation space.

### CROSS-REFERENCE TO RELATED APPLICATIONS

This application is based on and claims priority under 35 U.S.C. § 119 to Korean Patent Application No. 10-2024-0162274, filed on Nov. 14, 2024, and Korean Patent Application No. 10-2025-0033597, filed on Mar. 14, 2025, in the Korean Intellectual Property Office, the disclosures of which are incorporated by reference herein in their entirety.

### BACKGROUND

### 1. Field

Embodiments relate to an aerosol generating device capable of heating an aerosol generating article by using a dielectric heating method or a resistance heating method, depending on a type of the aerosol generating article.

### 2. Description of the Related Art

Recently, the demand for alternative methods that overcome the shortcomings of general cigarettes has increased. For example, the demand for a system that generates an aerosol by heating an aerosol generating article (or an ‘aerosol generating material’) using an aerosol generating device, rather than a method of generating an aerosol by burning a cigarette, has increased. Accordingly, the research on heating type aerosol generating devices is actively being conducted.

A heating temperature optimized for aerosol generation may vary depending on a composition ratio of an aerosol generating article. Various heating methods have been proposed to heat an aerosol generating article to an optimal temperature. For example, while it was common to heat an aerosol generating article by using a resistance heating method in the related art, a dielectric heating method has recently been proposed to heat an aerosol generating article by vibrating a dielectric included in the aerosol generating article using electromagnetic waves such that the aerosol generating article may be heated to a temperature different from that in the resistance heating method.

### SUMMARY

In the related art, it was common to design a dedicated aerosol generating article according to an aerosol generating device and use a single aerosol generating article, but recently, studies have been conducted to use various aerosol generating articles in a single aerosol generating device to provide a user with a variety of smoking sensations.

Although an optimal heating temperature varies depending on a type of an aerosol generating article, an existing aerosol generating device is able to heat the aerosol generating article only using one heating method, and thus, it is difficult to control a heating temperature depending on a type of an aerosol generating article.

Accordingly, embodiments provide an aerosol generating device capable of heating an aerosol generating article by selectively applying a dielectric heating method or a resistance heating method depending on a type of the aerosol generating article such that various types of aerosol generating articles are effectively heated, thereby improving a user's smoking sensation.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments.

An aerosol generating device according to an embodiment includes a housing including an accommodation space for accommodating an aerosol generating article, a battery arranged inside the housing, a source unit arranged inside the housing and configured to generate electromagnetic waves based on power supplied from the battery, a first conductive member arranged to surround at least a portion of the aerosol generating article accommodated in the accommodation space and configured to radiate the electromagnetic waves generated in the source unit towards the aerosol generating article to heat the aerosol generating article, a second conductive member arranged to surround at least a portion of the aerosol generating article accommodated in the accommodation space and configured to generate heat when power is supplied from the battery to heat the aerosol generating article, and a processor operatively connected to the battery, wherein the processor is configured to control the battery to supply power to one of the source unit and the second conductive member, based on a type of the aerosol generating article accommodated in the accommodation space.

### BRIEF DESCRIPTION OF THE DRAWINGS

The above and other aspects, features, and advantages of certain embodiments will be more apparent from the following description taken in conjunction with the accompanying drawings, in which:

FIG. 1 is a block diagram of an aerosol generating device according to an embodiment;

FIG. 2 is a perspective view of an aerosol generating device according to an embodiment;

FIG. 3 is a cross-sectional view of an aerosol generating device according to an embodiment;

FIG. 4 is an exploded perspective view of some components of the aerosol generating device of FIG. 3;

FIG. 5 is a flowchart for describing an operation of controlling power supply depending on a type of an aerosol generating article accommodated in an aerosol generating device, according to an embodiment;

FIG. 6 is a flowchart for describing an operation of controlling power supply based on a user's input on a display of an aerosol generating device, according to another embodiment;

FIG. 7 is a diagram showing a user interface output on a display of an aerosol generating device, according to another embodiment;

FIG. 8 is a flowchart for describing an operation of controlling power supply based on a user's input on a button unit of an aerosol generating device, according to another embodiment; and

FIG. 9 is a diagram showing a light-emitting unit of an aerosol generating device, according to another embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “unit”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the present specification, the detailed description of the related known art, which may obscure the subject matter of the embodiments of the present specification, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one component from another component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Embodiments may be implemented as software including one or more instructions stored in a storage medium (e.g., memory) readable by a machine (e.g., an aerosol generating device 1). For example, a processor (e.g., a controller) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The “non-transitory storage medium” is a tangible device and only means that it does not contain a signal (e.g., electromagnetic waves). This term does not distinguish a case in which data is stored semi-permanently in a storage medium from a case in which data is temporarily stored.

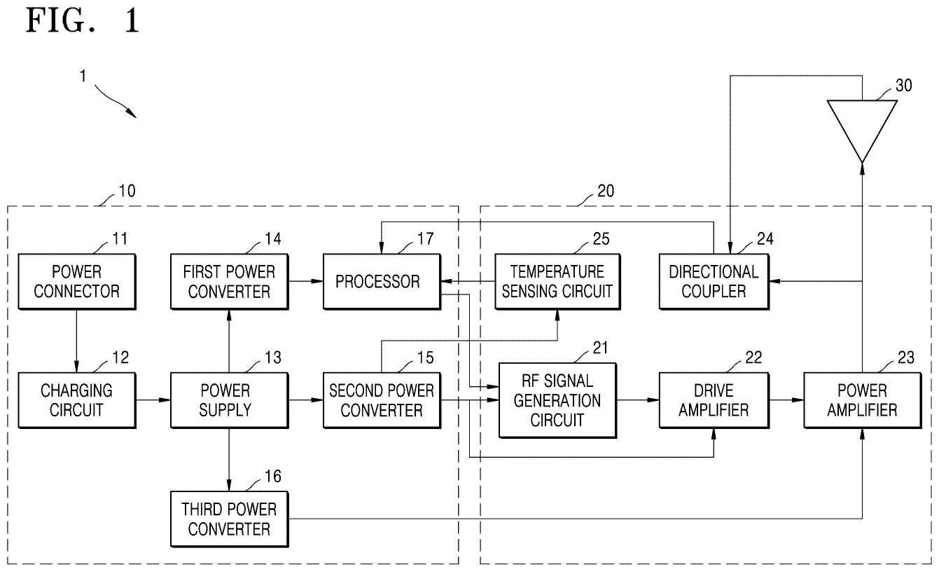

FIG. 1 is a block diagram of the aerosol generating device according to an embodiment.

According to an embodiment, an aerosol generating device 1 may include a control unit 10, a source unit 20, and a radiating unit 30. The control unit 10 may be a circuit for controlling basic operations of the aerosol generating device 1. The source unit 20 may be a circuit for generating a radio frequency (RF) signal under the control by the control unit 10. The radiating unit 30 may be a device for radiating the RF signal generated by the source unit 20 in the form of electromagnetic waves into a space (hereinafter, an insertion space) into which an aerosol generating article is inserted. Charges or ions of a dielectric (e.g., glycerin) included in the aerosol generating article may vibrate or rotate due to radiated electromagnetic waves (e.g., RF signals), and the aerosol generating article may be heated as the dielectric generates heat due to frictional heat generated in the process of the charges or ions vibrating or rotating. In other words, the aerosol generating device 1 may be a device that generates aerosols by heating the aerosol generating article in a dielectric heating method.

In an embodiment, the control unit 10 may include a power connector 11, a charging circuit 12, a power supply 13, a first power converter 14, a second power converter 15, a third power converter 16, and/or a processor 17. The source unit 20 may include an RF signal generation circuit 21, a drive amplifier 22, a power amplifier 23, a directional coupler 24, and/or a temperature sensing circuit 25. However, it will be understood by one of ordinary skill in the related art that some of the components illustrated in FIG. 1 may be omitted or new components may be added according to a design of the aerosol generating device 1.

The power connector 11 may be a physical connection device that is electrically connected to an electronic device or system (e.g., an external power supply) outside the aerosol generating device 1 and used to transmit and receive power. For example, the power connector 11 may receive power from an external power supply and transmit the received power to a component requiring charging (e.g., the power supply 13). The power connector 11 may also provide a path for data transmission. The aerosol generating device 1 may transmit and receive data to or from an external electronic device or system (e.g., a smartphone or a computer) through the power connector 11. The power connector 11 may include a universal serial bus (USB) power connector, a direct current (DC) power connector, or the like. In an example, the power connector 11 may include, but not limited to, a USB-C type connector capable of supplying 9 V of direct current (DC) voltage at a current of 1 A. The power connector 11 may also include an interface for transmitting and receiving power wirelessly.

The charging circuit 12 may refer to a circuit for charging the power supply 13. The charging circuit 12 may charge the power supply 13 by using power transmitted from the power connector 11. In an example, the charging circuit 12 may be implemented as a charger integrated circuit (IC), which is an IC that performs functions for efficiently and safely charging the power supply 13. The charging circuit 12 may monitor a charging status of the power supply 13 or optimize a charging process by monitoring a voltage, a current, and/or a temperature of the power supply 13. For example, the charging circuit 12 may detect a status of the power supply 13 and prevent overcharging or overdischarging by providing an appropriate charging voltage and current.

The power supply 13 may supply power for operations of the aerosol generating device 1. The power supply 13 may include one or more rechargeable batteries. The power supply 13 may supply power to the radiating unit 30 such that the radiating unit 30 may radiate electromagnetic waves (e.g., RF signals) into the insertion space to heat the aerosol generating article. Here, power supply to the radiating unit 30 may indicate power supply to the source unit 20. The power supply 13 may supply power required for operations of the processor 17, the RF signal generation circuit 21, the drive amplifier 22, the power amplifier 23, the temperature sensing circuit 25, and the like. In an example, the power supply 13 may include, but not limited to, a lithium polymer (LiPoly) battery. The power supply 13 may be a replaceable type (separated type) battery (hereinafter, a removable battery). The removable battery may be mounted in a battery holder provided within the aerosol generating device 1 or removed from the battery holder. The removable battery may be charged in a wired manner and/or a wireless manner.

The aerosol generating device 1 may include a power conversion circuit for converting power supplied from the power supply 13 into power (e.g., voltage and/or current) suitable for other components. The power conversion circuit may include at least one of a buck-converter, a buck-boost converter, a boost converter, a Zener diode, and a low-dropout (LDO) regulator. The power conversion circuit may include a DC/alternating current (AC) converter (e.g., an inverter) as required.

In an example, the aerosol generating device 1 may include the first power converter 14, the second power converter 15, and the third power converter 16. The first power converter 14 may be an LDO regulator for supplying power (e.g., a DC of 3.3 V) suitable for the processor 17, the second power converter 15 may be a buck-boost converter for supplying power (e.g., a DC of 5 V) suitable for the temperature sensing circuit 25, the RF signal generation circuit 21, and the drive amplifier 22, and the third power converter 16 may be a boost converter for supplying power (e.g., a DC of 12 V/25 W) suitable for the power amplifier 23.

The first power converter 14, the second power converter 15, and the third power converter 16 are not limited to the examples described above and may include other types of power conversion circuits. Although FIG. 1 illustrates the aerosol generating device 1 including three power converters, the aerosol generating device 1 may include more than three power converters or may include fewer power converters. In an example, at least some of the first power converter 14, the second power converter 15, and the third power converter 16 may be integrated into a single power converter.

The processor 17 may control general operations of the aerosol generating device 1. For example, the processor 17 may directly or indirectly control charging and discharging of the power supply 13 by using the charging circuit 12. The processor 17 may control the voltage and/or current output by a power conversion circuit by controlling a frequency and/or a duty ratio of a current pulse input to at least one switching element of the power conversion circuit. In addition to the components described above, the processor 17 may also control general operations of other components to be described later.

The processor 17 may be implemented as an array of multiple logic gates, or may be implemented as a combination of a general-purpose microcontroller unit (MCU) (or microprocessor) and a memory storing a program that may be executed in the MCU. It will be understood by one of ordinary skill in the art that the processor 17 may be implemented in other forms of hardware.

The RF signal generation circuit 21 may generate an RF signal based on power delivered from the power supply 13 or the second power converter 15. An RF signal may refer to a signal having a frequency within a range of about 300 MHz to about 300 GHz. In an example, the RF signal may have a frequency of about 1 GHz to about 100 GHz. Additionally, the RF signal may have a frequency in the Industrial Scientific and Medical equipment (ISM) band, for example, 915 MHz, 2.45 GHz, and/or 5.8 GHz.

The RF signal generation circuit 21 may include a voltage-controlled oscillator (VCO) that generates an RF signal having a different frequency depending on an input voltage. The RF signal generation circuit 21 may receive a control signal (e.g., a DC signal) from the processor 17 and generate an RF signal having a frequency corresponding to the received control signal. The processor 17 may store a control signal corresponding to a desired frequency in the form of a look-up table, or calculate a control signal corresponding to a desired frequency in real time through at least one operation.

In an example, the aerosol generating device 1 may further include a digital-to-analog converter (D/A converter) for converting a digital control signal output from the processor 17 into an analog control signal. The RF signal generation circuit 21 may receive the analog control signal and generate an RF signal having a frequency corresponding to the received analog control signal.

The drive amplifier 22 may amplify the RF signal generated by the RF signal generation circuit 21. For example, the drive amplifier 22 may provide an input signal suitable for a component of a next stage (e.g., the power amplifier 23) by amplifying a signal level (e.g., amplitude) of the RF signal. The drive amplifier 22 may reduce signal distortion by maintaining high linearity. However, because the drive amplifier 22 is an amplifier focused on increasing the signal level, the drive amplifier 22 may provide relatively low output power.

The power amplifier 23 may amplify power of an RF signal received from the drive amplifier 22. The power amplifier 23 may be an amplifier focused on providing sufficient power to a final output device (e.g., the radiating unit 30). For example, the power amplifier 23 may provide a high-power RF signal to the radiating unit 30 so that the radiating unit 30 may radiate electromagnetic waves into the insertion space to heat the aerosol generating article. The power amplifier 23 may perform an amplification operation by using power received through the third power converter 16 that provides higher power and/or voltage than the second power converter 15.

The drive amplifier 22 and the power amplifier 23 may include transistors such as a bipolar junction transistor (BJT) or a field effect transistor (FET), or a vacuum tube. In an example, the drive amplifier 22 and the power amplifier 23 may be, but not limited to, gallium nitride (GaN) transistors configured to handle high efficiency, high speed, and high voltage. The drive amplifier 22 and the power amplifier 23 may also include an operational amplifier.

In FIG. 1, the drive amplifier 22 and the power amplifier 23 are illustrated as individual amplifiers, but the drive amplifier 22 and the power amplifier 23 may be integrated into a single amplifier. Additionally, the drive amplifier 22 and/or the power amplifier 23 may be configured as a series connection, a parallel connection, and/or a combination thereof of a plurality of amplifiers.

The radiating unit 30 may include at least one antenna for radiating electromagnetic waves into space. At least one antenna may have a size and shape suitable for a size and shape of the aerosol generating article. For example, when the aerosol generating article is cylindrical in shape, at least one antenna may be tubular surrounding the aerosol generating article that is cylindrical. Here, the shape of the antenna being tubular may indicate that the overall shape of the antenna is tubular. In other words, when the antenna includes of a metal (e.g. SUS) track, this may indicate that the overall shape of the entire track is tubular. The shape of at least one antenna is not limited to the examples described above and may include various shapes such as a flat plate shape and a curved plate shape.

The radiating unit 30 may heat the aerosol generating article by radiating electromagnetic waves (e.g., an amplified RF signal or a transmitted RF signal) into the insertion space. For heating efficiency of the aerosol generating article to be increased, resonance of electromagnetic waves is to occur within the insertion space. Resonance conditions (e.g., a resonant frequency) of the insertion space may vary depending on the amount of dielectric contained in the inserted aerosol generating article. The processor 17 may control a frequency of the RF signal generated by the RF signal generation circuit 21 to correspond to or be close to the resonance conditions of the insertion space by adjusting the control signal input to the RF signal generation circuit 21. The processor 17 may use the directional coupler 24 to obtain information about the resonance conditions of the insertion space.

The directional coupler 24 may refer to a passive element having a waveguide structure that separates an incident wave and a reflected wave from each other. The directional coupler 24 may receive an RF signal transmitted from the power amplifier 23 toward the radiating unit 30, and electromagnetic waves reflected from the insertion space after being radiated by the radiating unit 30. The directional coupler 24 may separate the transmitted RF signal and the reflected electromagnetic waves, and provide the same to the processor 17.

In an example, the aerosol generating device 1 may further include an analog-to-digital converter (A/D converter) for converting an analog output of the directional coupler 24 into a digital output. The A/D converter may be built into the processor 17 or may exist as a separate component outside the processor 17. The processor 17 may analyze characteristics (e.g., a current, a voltage, power, a phase, and/or a frequency) of the transmitted RF signal and characteristics (e.g., a current, a voltage, power, a phase, and/or a frequency) of the reflected electromagnetic waves by monitoring the output of the directional coupler 24.

The processor 17 may determine whether the operation of the source unit 20 is being performed as intended, based on the characteristics of the transmitted RF signal. Additionally, the characteristics of the transmitted RF signal may be used to determine heating efficiency of the source unit 20 or the radiating unit 30, together with the characteristics of the reflected electromagnetic waves. The processor 17 may control the source unit 20 such that the heating efficiency of the source unit 20 or the radiating unit 30 is maximized. For example, the processor 17 may adjust the frequency of the RF signal generated by the RF signal generation circuit 21 such that power of the reflected electromagnetic waves is minimized. Minimizing the power of the reflected electromagnetic waves may indicate that the frequency of the RF signal is closer to the resonance conditions of the insertion space. The characteristics of the transmitted RF signal may provide a criterion for whether the power of the reflected electromagnetic waves is minimized.

Because resonance of electromagnetic waves may occur in the insertion space depending on the frequency of the RF signal, the insertion space may be referred to as a resonant section. At least a portion of the insertion space may be surrounded by at least one shielding member to prevent the electromagnetic waves from leaking outside the aerosol generating device 1. In an embodiment, the insertion space may further include a physical structure to ensure that the resonance conditions are within a range controllable by the processor 17. The physical structure may include at least one conductor, and the resonance conditions of the insertion space may vary depending on an arrangement, a thickness, and a length of the conductor. Additionally, the physical structure may include a space for accommodating a dielectric having low electromagnetic absorption, separate from the dielectric contained in the aerosol generating article. The dielectric with low electromagnetic absorption may change a resonant frequency of the entire resonant section without absorbing energy that is to be transferred to a heated material. Accordingly, even when the resonant section is reduced in size, the resonance conditions may be determined within a range controllable by the processor 17.

The temperature sensing circuit 25 may be arranged in contact with or adjacent to components included in the source unit 20 to measure a temperature of the source unit 20. For example, the temperature sensing circuit 25 may be arranged in contact with or adjacent to at least one of the RF signal generation circuit 21, the drive amplifier 22, and the power amplifier 23. Heat may be generated due to limited efficiency in a process of generating and/or amplifying RF signals, and when excessive heat is generated, the heat may have a negative impact on components included in the source unit 20 or other components included in the aerosol generating device 1. The temperature measured by the temperature sensing circuit 25 may be used to prevent overheating of the source unit 20.

The processor 17 may receive the measured temperature (or a value corresponding to the temperature) from the temperature sensing circuit 25, and when it is determined that the source unit 20 is overheated, the processor 17 may stop the operation of the source unit 20. For example, the processor 17 may stop the operation of the source unit 20 by cutting off the power supply to the source unit 20 or transmitting a control signal. Hereinafter, the term “power supply to the source unit 20” is used to indicate controlling whether to operate the source unit 20.

The temperature sensing circuit 25 may include at least one temperature sensor among a thermocouple, a resistance temperature detector (RTD), a thermistor, a semiconductor temperature sensor, and an optical temperature sensor. In an example, the temperature sensing circuit 25 may be implemented as a chip-type sensor (e.g., a negative temperature coefficient (NTC) sensor) to minimize the area occupied, but is not limited thereto.

The aerosol generating device 1 may include other components in addition to the components illustrated in FIG. 1. For example, the aerosol generating device 1 may further include a sensor unit, an output unit, an input unit, a communication unit, and a memory. In addition, when the aerosol generating device 1 is a hybrid-type device that uses both an aerosol generating article and a cartridge, the aerosol generating device 1 may further include a cartridge heater. The cartridge heater may receive power from the power supply 13 to heat a medium and/or an aerosol generating material within the cartridge.

The aerosol generating device 1 may further include a heater (or an aerosol generating article heater) for selectively heating the aerosol generating article in a resistance heating method in addition to a dielectric heating method through the radiating unit 30. The heater may heat the aerosol generating article by generating heat according to power supplied from the power supply 13.

In an embodiment, the sensor unit may detect a status of the aerosol generating device 1 or a status around the aerosol generating device 1 and transmit the detected information to the processor 17. For example, the sensor unit may include a temperature sensor, a puff sensor, an insertion detection sensor, a reuse detection sensor, an overly moist detection sensor, a cigarette identification sensor, a cartridge detection sensor, a cap detection sensor, and/or a motion detection sensor. The sensor unit may further include various sensors, such as a liquid remaining amount sensor for detecting the remaining liquid amount of the cartridge, and an immersion sensor for detecting immersion of the aerosol generating device 1.

In an embodiment, the temperature sensor may detect the temperature of the insertion space or the aerosol generating article. The temperature sensor may be positioned in contact with or adjacent to the insertion space or the aerosol generating article to directly measure the temperature of the insertion space or the aerosol generating article. Additionally, the temperature sensor may be positioned to be spaced apart from the insertion space or the aerosol generating article to indirectly measure the temperature of the insertion space or the aerosol generating article (e.g., in a non-contact manner). In an example, the temperature sensor may include an optical temperature sensor (e.g., an infrared temperature sensor).

In an embodiment, the temperature sensor may detect the temperature of the power supply 13. The temperature sensor may be arranged adjacent to the power supply 13. For example, the temperature sensor may be attached to one surface of the power supply 13 (e.g., a battery) and/or mounted on one surface of a printed circuit board. For example, the aerosol generating device 1 may include a protection circuit module (PCM), and the temperature sensor may be positioned adjacent to the power supply 13 together with the PCM.

In an embodiment, the temperature sensor may be arranged inside a housing (not shown) of the aerosol generating device 1 to detect a temperature inside the housing.

In an embodiment, the puff sensor may detect a user's puff.

For example, the puff sensor may include a pressure sensor. The pressure sensor may output a signal corresponding to internal pressure of the aerosol generating device 1, and the processor 17 may detect a user's puff based on the signal corresponding to the internal pressure. The internal pressure of the aerosol generating device 1 may correspond to pressure of an airflow path through which a gas flows. The puff sensor may be arranged to correspond to the airflow path, through which gas flows, in the aerosol generating device 1.

In another example, the puff sensor may include a temperature sensor. When the user puffs, a temporary temperature drop may occur in the airflow path, the insertion space, the aerosol generating article, and the like. The processor 17 may detect the user's puff based on a signal corresponding to the temperature of the airflow path, or the like, output from the temperature sensor.

In another example, the puff sensor may include both the pressure sensor and the temperature sensor. In this case, the temperature sensor may measure a temperature which is used to correct the internal pressure measured by the pressure sensor. For example, the puff sensor may correct the signal corresponding to internal pressure, based on the temperature measured by the temperature sensor and output the corrected signal. In another example, the puff sensor may output a signal corresponding to the temperature measured by the temperature sensor and the signal corresponding to the internal pressure measured by the puff sensor. In this case, the processor 17 may receive the signals and correct the signal corresponding to the internal pressure, based on the signal corresponding to the temperature.

In another example, the puff sensor may include a capacitance-based sensor. In the disclosure, the capacitance-based sensor may also be referred to as a capacitive sensor. When the user puffs, a temperature change and/or an aerosol flow may occur within the insertion space, thereby changing permittivity within the insertion space. The processor 17 may detect the user's puff based on a signal corresponding to the permittivity inside the insertion space output from the capacitive sensor.

The puff sensor is not limited to the examples described above and may be implemented with various sensors to detect the user's puff.

In an embodiment, the insertion detection sensor may detect insertion and/or removal of the aerosol generating article. The insertion detection sensor may be installed around the insertion space.

For example, the insertion detection sensor may include a capacitive sensor. The capacitive sensor may include at least one conductor, wherein the at least one conductor may be positioned adjacent to the insertion space. When the aerosol generating article is inserted into or removed from the insertion space, the permittivity around the conductor may change. The processor 17 may detect insertion and/or removal of the aerosol generating article based on a signal corresponding to the permittivity inside the insertion space, output from the capacitive sensor.

In another example, the insertion detection sensor may include an inductive sensor. The inductive sensor may include at least one coil, wherein the at least one coil may be positioned adjacent to the insertion space. When the aerosol generating article (e.g., a wrapper for the aerosol generating article) contains a conductor, a change in a magnetic field may occur around the current-carrying coil when the aerosol generating article is inserted into or removed from the insertion space. The processor 17 may detect insertion and/or removal of the aerosol generating article including the conductor, based on characteristics of a current output from or detected by the inductive sensor (e.g., a frequency of an alternating current, a current value, a voltage value, an inductance value, and an impedance value). Alternatively, the aerosol generating article (e.g., a medium portion of the aerosol generating article) may include a susceptor (e.g., SUS). Even in this case, a change in the magnetic field around the coil may occur based on the insertion or removal of the susceptor or the like within the insertion space, and the processor 17 may also detect the insertion and/or removal of the aerosol generating article, based on the characteristics of the current of the inductive sensor.

The insertion detection sensor is not limited to the examples described above and may be implemented using various sensors (e.g., proximity sensors) for detecting insertion and/or removal of the aerosol generating article. Additionally, the insertion detection sensor may include any combination of the examples described above. In an embodiment, the insertion detection sensor may include a switch or the like for detecting compression by the aerosol generating article.

In an embodiment, the reuse detection sensor may detect whether the aerosol generating article is reused. For example, the reuse detection sensor may be a color sensor for detecting a color of the aerosol generating article. When the aerosol generating article is used by the user, a change in color of a portion of the wrapper surrounding the outside of the aerosol generating article may occur due to generated aerosols or heating. The color sensor may output a signal corresponding to optical characteristics (e.g., a wavelength of light) corresponding to the color of the wrapper, based on light reflected from the wrapper. The processor 17 may determine that the aerosol generating article inserted into the insertion space has already been used when a change in color of a portion of the wrapper is detected.

In an embodiment, the overly moist detection sensor may detect whether the aerosol generating article is overly moist. For example, the overly moist detection sensor may include a capacitive sensor. The capacitive sensor may include at least one conductor positioned adjacent to the insertion space. The processor 17 may detect whether the aerosol generating article is overly moist, based on a level of a signal corresponding to a permittivity or the like output from the capacitive sensor. For example, the processor 17 may determine a level range within which the level of the signal is included, based on a look-up table, and determine moisture content of the aerosol generating article, based on the determined level range.

In an embodiment, the cigarette identification sensor may detect whether the aerosol generating article is authentic and/or detect a type of the aerosol generating article.

For example, the cigarette identification sensor may include an optical sensor for detecting an identification material (or identification tag) located on an outer surface of the aerosol generating article (e.g., the wrapper). The optical sensor may irradiate light toward the identification material (or identification tag) of the aerosol generating article and detect, based on the reflected light, whether the aerosol generating article is authentic and/or the type of the aerosol generating article. For example, the identification material may include a material that emits light of a particular wavelength, based on the irradiated light. The processor 17 may detect whether the aerosol generating article is authentic and/or the type of the aerosol generating article, based on the range of the wavelength.

In another example, the cigarette identification sensor may include a capacitive sensor. Depending on the type of aerosol generating article inserted into the insertion space, the permittivity inside the insertion space may vary. The processor 17 may detect whether the aerosol generating article is authentic and/or the type thereof, based on a signal corresponding to the permittivity inside the insertion space, output from the capacitive sensor.

In another example, the cigarette identification sensor may include an inductive sensor. When a conductor is included in the wrapper and/or interior (e.g., the medium portion) of the aerosol generating article inserted into the insertion space, characteristics of the current detected by the inductive sensor (e.g., a frequency of an AC current, a current value, a voltage value, an inductance value, and an impedance value) may vary depending on the type of the aerosol generating article inserted into the insertion space. The processor 17 may detect whether the inserted aerosol generating article is authentic and/or the type thereof, based on the characteristics of the current output from or detected by the inductive sensor.

The cigarette identification sensor is not limited to the examples described above and may be implemented using various sensors to detect whether the aerosol generating article is authentic and/or to detect the type of the aerosol generating article. Additionally, the cigarette identification sensor may include any combination of the examples described above.

In an embodiment, the cartridge detection sensor may detect mounting and/or removal of a cartridge. For example, the cartridge detection sensor may include an inductive sensor, a capacitive sensor, a resistive sensor, a hall sensor (hall IC) and/or an optical sensor.

In an embodiment, a cap detection sensor may detect mounting and/or removal of a cap. For example, the cap detection sensor may include an inductive sensor, a capacitive sensor, a resistive sensor, a contact sensor, a hall sensor (hall IC) and/or an optical sensor. The cap may include a structure that covers at least a portion of the cartridge mounted or inserted into the aerosol generating device 1, or covers at least a portion of the housing of the aerosol generating device 1. The cap detection sensor may output a signal corresponding to the mounting or removal of the cap when the cap is mounted on or removed from the housing, and the processor 17 may detect the mounting or removal of the cap based on the signal corresponding to the mounting or removal.

According to an embodiment, the motion detection sensor may detect movement of the aerosol generating device 1. The motion detection sensor may be implemented using at least one of an acceleration sensor or a gyro sensor.

In an embodiment, the sensor unit may further include, in addition to the sensors described above, at least one of a humidity sensor, an atmospheric pressure sensor, a magnetic sensor, a position sensor (global positioning system (GPS)), or a proximity sensor. Functions of the sensors would be instinctively understood by one of ordinary skill in the art in view of their names, and thus, detailed descriptions thereof are omitted herein.

In an embodiment, the output unit may output information about the status of the aerosol generating device 1. The output unit may include, but not limited to, a display, a haptic unit, and/or an audio output unit. For example, information about the aerosol generating device 1 may include a charging/discharging status of the power supply 13 of the aerosol generating device 1, an operating status of the source unit 20 or the radiating unit 30, an insertion/removal status of the aerosol generating article and/or the cartridge, a mounting and/or removal status of the cap, or a status in which the use of the aerosol generating device 1 is limited (e.g., detection of an abnormal article). The display may visually provide information to the user about the status of the aerosol generating device 1. For example, the display may include a light-emitting diode (LED) light emitting element, a liquid crystal display (LCD) panel, an organic light-emitting diode (OLED) display panel, etc. When the display includes a touchpad, the display may also be used as an input device. The haptic unit may provide information about the status of the aerosol generating device 1 to the user in a tactile manner. For example, the haptic unit may include a vibration motor, a piezoelectric element, an electrical stimulation device, and the like. The audio output unit may provide information about the aerosol generating device 1 to the user audibly. For example, the audio output unit may convert an electrical signal into an audio signal and output the same externally.

In an embodiment, the input unit may receive information input from the user. For example, the input unit may include a touch panel, a button, a key pad, a dome switch, a jog wheel, a jog switch, and the like.

In an embodiment, the memory may be hardware that stores various types of data processed within the aerosol generating device 1, and may store data processed and to be processed by the processor 17. For example, the memory may include at least one type of storage medium among a flash memory type, a hard disk type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. For example, the memory may store data about an operation time of the aerosol generating device 1, a maximum number of puffs, a current number of puffs, at least one temperature profile, and the user's smoking pattern.

In an embodiment, the communication unit may include at least one component for communicating with another electronic device (e.g., a portable electronic device). For example, the communication unit may include a Bluetooth communication unit, a Bluetooth low energy (BLE) communication unit, a near field communication unit, a wireless local area network (WLAN) communication unit, a Zigbee communication unit, an infrared (Infrared Data Association (IrDA)) communication unit, a wireless fidelity direct (WFD) communication unit, a ultra-wideband (UWB) communication unit, an Adaptive Network Topology (ANT)+ communication unit, a cellular network communication unit, an Internet communication unit, a computer network (e.g., a local area network (LAN) or wide-area network (WAN)) communication unit, or the like.

In an embodiment, the processor 17 may control the temperature of the insertion space or the aerosol generating article by controlling an amplification factor of the source unit 20 (e.g., the power amplifier 23). The processor 17 may control the amplification factor of the source unit 20 (e.g., the power amplifier 23), based on the temperature of the insertion space or the aerosol generating article, detected using the temperature sensor. The processor 17 may control the amplification factor of the source unit 20 (e.g., the power amplifier 23), based on a temperature profile and/or a power profile stored in the memory.

The processor 17 may heat the aerosol generating article by using the resistance heating method instead of the dielectric heating method by controlling supply of power of the power supply 13 to the heater (or the aerosol generating article). For example, the processor 17 may heat the aerosol generating article by using the resistance heating method by supplying, through the power supply 13, the power only to the heater and not to the source unit 20.

Additionally, the processor 17 may control the temperature of the cartridge heater by controlling the supply of power from the power supply 13 to the cartridge heater. The processor 17 may control the temperature of the cartridge heater and/or power supplied to the cartridge heater, based on the temperature of the cartridge heater detected using the temperature sensor. The processor 17 may control the temperature of the cartridge heater and/or the power supplied to the cartridge heater, based on the temperature profile and/or the power profile stored in the memory.

In an embodiment, the processor 17 may prevent the insertion space, the aerosol generating article, and/or the cartridge heater from overheating. For example, the processor 17 may control the operation of the power conversion circuit to reduce the amount of power supplied to the source unit 20 or the cartridge heater, or to stop supplying power to the source unit 20 or the cartridge heater, based on a determination that temperature of the insertion space, the aerosol generating article, and/or the cartridge heater exceeds a preset threshold temperature.

In an embodiment, the processor 17 may control power supply to the source unit 20 or the cartridge heater, based on a result detected by the sensor unit.

In an embodiment, the processor 17 may control power supply to the source unit 20 or the cartridge heater, based on insertion and/or removal of the aerosol generating article into or from the insertion space. For example, the processor 17 may control power to be supplied to the source unit 20 or the cartridge heater when it is determined that the aerosol generating article has been inserted into the insertion space by using the insertion detection sensor. The processor 17 may cut off the power supply to the source unit 20 or the cartridge heater when it is determined that the aerosol generating article has been removed from the insertion space by using the insertion detection sensor. The processor 17 may determine that the aerosol generating article has been removed from the insertion space, when the temperature of the insertion space or the aerosol generating article is above a limited temperature or when a temperature change gradient of the insertion space or the aerosol generating article is equal to or above a set gradient.

In an embodiment, the processor 17 may control a power supply time and/or a power supply amount of power supplied to the source unit 20 or the cartridge heater, based on the status of the aerosol generating article. For example, the processor 17 may increase the power supply time (e.g., preheating time) of power supply to the source unit 20 or the cartridge heater, when it is determined that the aerosol generating article is in an overly moist state by using the overly moist detection sensor.

In an embodiment, the processor 17 may control power supply to the source unit 20 or the cartridge heater, based on whether the aerosol generating article is reused. For example, the processor 17 may cut off power supply to the source unit 20 or the cartridge heater when it is determined that the aerosol generating article has been used.

In an embodiment, the processor 17 may control power supply to the source unit 20 or the cartridge heater, based on whether the cartridge is coupled and/or removed. For example, the processor 17 may stop supplying power to the source unit 20 or the cartridge heater or control power not to be supplied to the source unit 20 or the cartridge heater when it is determined, by using the cartridge detection sensor, that the cartridge is removed.

In an embodiment, the processor 17 may control power supply to the source unit 20 or the cartridge heater, based on whether the aerosol generating material in the cartridge is exhausted. For example, the processor 17 may determine that the aerosol generating material in the cartridge is exhausted when it is determined that the temperature of the cartridge heater exceeds a limit temperature while preheating the cartridge heater (i.e., during a preheating period). When it is determined that the aerosol generating material in the cartridge has been exhausted, the processor 17 may cut off the supply of power to the source unit 20 or the cartridge heater.

In an embodiment, the processor 17 may control power supply to the source unit 20 or the cartridge heater, based on availability of the cartridge. For example, the processor 17 may determine that the cartridge is no longer usable when it is determined that the current number of puffs is equal to or greater than the maximum number of puffs set for the cartridge based on data stored in the memory. Alternatively, the processor 17 may determine that the cartridge is unusable when a total time that the cartridge heater has been heated is equal to or greater than a preset maximum time or a total amount of power supplied to the cartridge heater is equal to or greater than a preset maximum amount of power. In this case, the processor 17 may stop supplying power to the source unit 20 or the cartridge heater or control power not to be supplied to the source unit 20 or the cartridge heater.

In an embodiment, the processor 17 may control power supply to the source unit 20 or the cartridge heater, based on the user's puff. For example, the processor 17 may use the puff sensor to determine whether a puff has occurred and/or determine intensity of the puff. The processor 17 may cut off the power supply to the source unit 20 or the cartridge heater when the number of puffs reaches a preset maximum number of puffs and/or when no puffs are detected for a preset period of time. The processor 17 may also control the supply of power to the source unit 20 or the cartridge heater when a puff is detected.

In an embodiment, the processor 17 may control power supply to the source unit 20 or the cartridge heater, based on the authenticity and/or type of the aerosol generating article (or the cartridge). For example, the processor 17 may use the cigarette identification sensor to detect the authenticity and/or type of the aerosol generating article (or the cartridge). For example, the processor 17 may cut off power supply to the source unit 20 or the cartridge heater when the aerosol generating article (or the cartridge) is detected to be counterfeit. The processor 17 may control (e.g., initiate) the supply of power to the source unit 20 or the cartridge heater when the aerosol generating article (or the cartridge) is detected to be authentic. In another example, the processor 17 may control power supply to the source unit 20 or the cartridge heater differently depending on the type of the aerosol generating article (or the cartridge). The processor 17 may control the amplification factor of the source unit 20 or the temperature and/or power of the cartridge heater, based on a first temperature profile (or a first power profile) when the aerosol generating article (or the cartridge) is detected to be a first aerosol generating article (or a first cartridge), and may control the amplification factor of the source unit 20 or the temperature and/or power of the cartridge heater, based on a second temperature profile (or a second power profile) when the aerosol generating article (or the cartridge) is detected to be a second aerosol generating article (or a second cartridge).

In an embodiment, the processor 17 may control the output unit, based on a result detected by the sensor unit. For example, the processor 17 may control the output unit to provide visual, tactile and/or auditory information indicating that the aerosol generating device 1 is about to be terminated, when the number of puffs counted using the puff sensor reaches a preset number. For example, the processor 17 may control the output unit to provide visual, tactile and/or auditory information about the temperature of the insertion space, the aerosol generating article, or the cartridge heater.

In an embodiment, the processor 17 may store, in the memory, and update a history of events that has occurred, based on the occurrence of a given event. For example, the event may include operations such as detection of insertion of an aerosol generating article, initiation of heating of an aerosol generating article, detection of a puff, termination of a puff, detection of overheating, detection of overvoltage application to a cartridge heater, termination of heating of an aerosol generating article, turning on/off power of the aerosol generating device 1, initiation of charging of the power supply 13, detection of overcharge of the power supply 13, or termination of charging of the power supply 13, performed in the aerosol generating device 1. For example, the history of events may include the time an event has occurred, log data corresponding to the event, and the like. For example, when a given event is detection of insertion of an aerosol generating article, log data corresponding to the event may include data about sensing values of an insertion detection sensor, and the like. For example, when a given event is overheating detection of a cartridge heater, log data corresponding to the event may include data about a temperature of the cartridge heater, a voltage applied to the cartridge heater, a current flowing through the cartridge heater, and the like.

In an embodiment, the processor 17 may control the communication unit to form a communication link with an external device, such as the user's mobile terminal.

In an embodiment, the processor 17 may release a limit on the use of at least one function (e.g., a heating function) of the aerosol generating device 1 when data regarding authentication is received from the external device through the communications link. For example, the data regarding authentication may include the user's date of birth, a unique number that identifies the user, whether the user has completed authentication, or the like.

In an embodiment, the processor 17 may transmit data about the status of the aerosol generating device 1 to the external device via the communication link (e.g., remaining capacity of the power supply 13 or an operating mode). The transmitted data may be output through a display of an external device, or the like.

In an embodiment, when a request for location search of the aerosol generating device 1 is received from the external device via the communication link, the processor 17 may control the output unit to perform an operation corresponding to the location search. For example, the processor 17 may control the haptic unit to generate vibration or control the display to output an object corresponding to the location search and search termination.

In an embodiment, the processor 17 may perform a firmware update when firmware data is received from the external device via the communication link.

In an embodiment, the processor 17 may transmit data about sensed values of at least one sensor unit to an external server (not shown) via the communication link, and receive, from a server, and store a learning model generated by learning the sensed values through machine learning, such as deep learning. The processor 17 may perform operations such as determining the user's inhalation pattern and generating the temperature profile by using the learning model received from the server.

Although not illustrated in FIG. 1, the aerosol generating device 1 may further include a power protection circuit. The power protection circuit may include at least one switching element and may cut off a current path to the power supply 13 in response to overcharge and/or overdischarge of the power supply 13.

The aerosol generating article as described herein may include at least one aerosol generating rod (e.g., a medium portion) and at least one filter rod. The radiating unit 30 may be arranged to correspond to at least one aerosol generating rod, and may be designed differently depending on an arrangement order and/or positions of the aerosol generating rod and the filter rod. The aerosol generating rod may include at least one of nicotine, an aerosol generating material, and an additive. For example, the aerosol generating material may include glycerin (e.g., vegetable glycerin (VG)) and/or propylene glycol (PG), and may also include various other materials. For example, the additive may include flavoring agents and/or organic acids, and may also include various other substances. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco, reconstituted tobacco, etc.). The tobacco material may be included in the aerosol generating rod in various forms, such as cut tobacco, granules, or powder. In an embodiment, the additive of the aerosol generating rod may include a basic substance. Based on the basic material, the nicotine of the tobacco material included in the aerosol generating rod may have an alkaline pH (e.g., pH 7.0 or higher). In this case, freebase nicotine may be released from the aerosol generating rod even at low temperatures. In an embodiment, the aerosol generating rod may include two or more aerosol generating rods, wherein the two or more aerosol generating rods may each include tobacco material and/or non-tobacco material. Although not shown, at least one aerosol generating rod and at least one filter rod may be individually and/or integrally wrapped by at least one wrapper. In the disclosure, the aerosol generating article may be referred to as a stick.

The cartridge referred to in the disclosure may include an aerosol generating material having any one of a liquid state, a solid state, a gaseous state, or a gel state therein. The aerosol generating material may include a liquid composition. For example, the liquid composition may be a liquid including a tobacco-containing material including a volatile tobacco flavor component, or may be a liquid including a non-tobacco material. The cartridge may include a storage portion containing an aerosol generating material and/or a liquid transfer means impregnated with (containing) the aerosol generating material. For example, the liquid transfer medium may include a wick such as cotton fibers, ceramic fibers, glass fibers, and porous ceramics. The cartridge heater may be included in the cartridge in the form of a coil surrounding (or winding) the liquid transfer means or in a structure contacting one side of the liquid transfer means. Alternatively, the cartridge heater may be included in the aerosol generating device 1 that is separable from the cartridge.

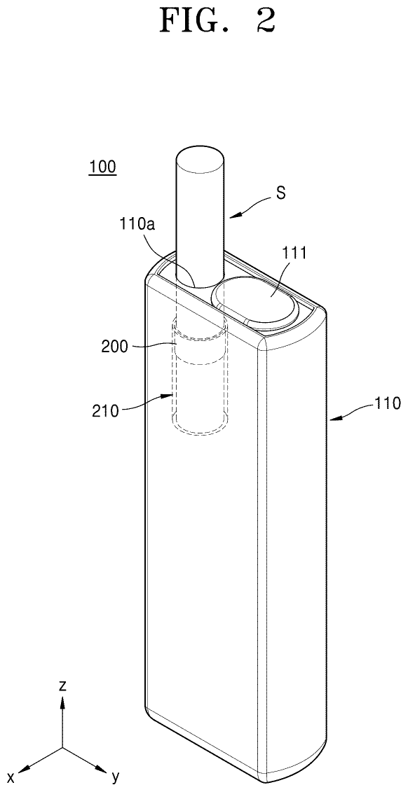

FIG. 2 is a perspective view of an aerosol generating device according to an embodiment.

Referring to FIG. 2, an aerosol generating device 100 (e.g., the aerosol generating device 1 of FIG. 1) according to an embodiment may include a housing 110 accommodating an aerosol generating article S, a first conductive member 200 configured to heat the aerosol generating article S, and a second conductive member 210 configured to heat the aerosol generating article S in a manner different from the first conductive member 200. Components of the aerosol generating device 100 are not limited to those shown in FIG. 2, and another component (e.g., a cover 111 of FIG. 2) may be added or at least one of the illustrated components may be omitted, according to an embodiment.

The housing 110 may include an accommodation space 110a (or an insertion space) in which the aerosol generating article S may be accommodated, and configure an overall exterior of the aerosol generating device 100. Components of the aerosol generating device 100 may be arranged in an internal space of the housing 110. For example, the first conductive member 200, the second conductive member 210, a battery, a processor (e.g., the control unit 10 of FIG. 1), and/or a source unit (e.g., the source unit 20 of FIG. 1) may be arranged in the internal space of the housing 110, but the components of the aerosol generating device 100 arranged in the internal space of the housing 110 are not limited thereto.

The first conductive member 200 may radiate electromagnetic waves towards the aerosol generating article S accommodated in the accommodation space 110a to heat the aerosol generating article S. For example, the first conductive member 200 may radiate the electromagnetic waves towards the accommodation space 110a when an RF signal is supplied from the source unit. The electromagnetic waves may be microwaves in a frequency band of, for example, about 300 MHz to about 300 GHz, but are not limited thereto. In an embodiment, the first conductive member 200 may be referred to as an antenna.

When the electromagnetic waves are radiated from the first conductive member 200 towards the aerosol generating article S, charges or ions of a dielectric included in the aerosol generating article S may vibrate or rotate. Frictional heat may be generated when the charges or ions vibrate or rotate, and the aerosol generating article S may be heated when the dielectric is heated according to the frictional heat. In other words, the first conductive member 200 may heat the aerosol generating article S by using a dielectric heating method.

The second conductive member 210 may be arranged to surround the aerosol generating article S accommodated in the accommodation space 110a, inside the housing 110, and may generate heat to heat the aerosol generating article S when power is supplied. For example, the second conductive member 210 may include a conductive pattern generating heat when power is supplied, and generate heat to heat the aerosol generating article S when power is supplied from the battery (not shown). In other words, the second conductive member 210 may heat the aerosol generating article S by using a resistance heating method.

The aerosol generating device 100 according to an embodiment may heat the aerosol generating device 100 by selectively using the dielectric heating method or the resistance heating method through the first conductive member 200 or the second conductive member 210. For example, in a first mode (or a dielectric heating mode), the aerosol generating device 100 may heat the aerosol generating article S by using the dielectric heating method by radiating the electromagnetic waves through the first conductive member 200. In another example, in a second mode (or a resistance heating mode), the aerosol generating device 100 may heat the aerosol generating article S by using the resistance heating method through heat generated in the second conductive member 210.

When the aerosol generating article S is heated by the first conductive member 200 or the second conductive member 210, vapor may be generated from the aerosol generating article S and the generated vapor may be mixed with external air introduced into the accommodation space 110a, and thus, aerosols may be generated inside the accommodation space 110a. Here, a user may inhale the aerosols generated in the accommodation space 110a by bringing the mouth in contact with the aerosol generating article S and performing an inhalation motion.

In an embodiment, the aerosol generating device 100 may further include the cover 111 movably arranged in the housing 110 to open or close the accommodation space 110a. For example, the cover 111 may be arranged so as to cover the accommodation space 110a at a first position (or a closing position) and prevent the accommodation space 110a from being exposed to the outside by closing the accommodation space 110a. The cover 111 may prevent the accommodation space 110a from being exposed to the outside at the first position, thereby preventing introduction of external foreign substances into the accommodation space 110a. In another example, the cover 111 may open the accommodation space 110a by moving from the first position to a second position (or an opening position), to expose the accommodation space 110a to the outside. When the cover 111 is arranged at the second position, the accommodation space 110a may be exposed to the outside, and thus, the user may insert the aerosol generating article S into the accommodation space 110a.

In an embodiment, a guide groove (not shown) may be formed in one region (e.g., a region facing a z-axis direction) of the housing 110, and the cover 111 may slide between the first position and the second position along the guide groove, but a moving method of the cover 111 is not limited thereto. Also, the cover 111 that has moved from the first position to the second position may move back to the first position according to an elastic force even when there is no separate operation of the user, but an embodiment is not limited thereto.

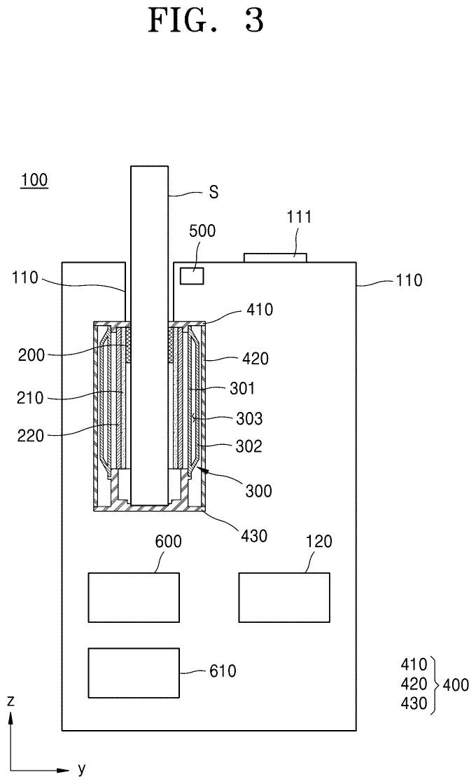

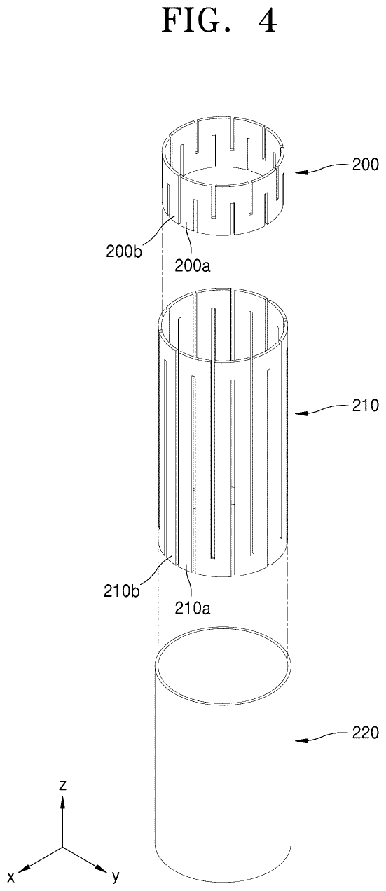

Hereinafter, components arranged inside the housing 110 of the aerosol generating device 100 will be described in detail with reference to FIGS. 3 and 4.

FIG. 3 is a cross-sectional view of the aerosol generating device according to an embodiment, and FIG. 4 is an exploded perspective view of some components of the aerosol generating device of FIG. 3. Here, FIG. 3 is a cross-sectional view of the aerosol generating device 100 of FIG. 2 taken along an yz plane, and FIG. 4 is an exploded perspective view of the first conductive member 200, the second conductive member 210, and a support 220 of the aerosol generating device 100 of FIG. 3.

Referring to FIGS. 3 and 4, the aerosol generating device 100 (e.g., the aerosol generating device 100 of FIG. 2) according to an embodiment may include the housing 110 (e.g., the housing 110 of FIG. 2), a source unit 120 (e.g., the source unit 20 of FIG. 1), the first conductive member 200 (e.g., the first conductive member 200 of FIG. 2), the second conductive member 210 (e.g., the second conductive member 210 of FIG. 2), a sensor 500, a battery 600 (e.g., the power supply 13 of FIG. 1), and a processor 610 (e.g., the control unit 10 of FIG. 1). Components of the aerosol generating device 100 are not limited thereto, and at least one component (e.g., the sensor 500) may be omitted or another component (e.g., an insulator 300 or a fixing member 400) may be added, according to an embodiment.

The housing 110 may include the accommodation space 110a for accommodating the aerosol generating article S, and the internal space in which the components of the aerosol generating device 100 may be arranged may be provided inside the housing 110. At least a portion of the aerosol generating article S may be inserted into the housing 110 through an insertion hole of the accommodation space 110a, and then accommodated in the accommodation space 110a.

In an embodiment, the housing 110 may further include the cover 111 that is movably arranged in one region (e.g., a region in the z-axis direction) of the housing 110 and capable of opening or closing the accommodation space 110a. The cover 111 may be substantially the same as or similar to the cover 111 of FIG. 2, and redundant descriptions thereof are omitted below.

The source unit 120 may include a circuit arranged inside the housing 110 and capable of generating an RF signal when power is supplied. The source unit 120 may generate the RF signal when power is supplied from the battery 600, and amplify the generated RF signal. For example, the source unit 120 may amplify a signal level (e.g., amplitude) and/or power of the generated RF signal. The RF signal generated by the source unit 120 and having the amplified signal level and/or power may be transmitted to the first conductive member 200.

The first conductive member 200 may be electrically or operatively connected to the source unit 120, and radiate electromagnetic waves towards the accommodation space 110a according to the RF signal supplied from the source unit 120. For example, the first conductive member 200 may be arranged to surround an outer circumference of the accommodation space 110a, inside the housing 110, and radiate microwaves towards the aerosol generating article S accommodated in the accommodation space 110a.

When the electromagnetic waves are radiated from the first conductive member 200 towards the aerosol generating article S, the charges or ions of the dielectric (e.g., glycerin) included in the aerosol generating article S may vibrate or rotate to generate the frictional heat from the dielectric, and the aerosol generating article S may be heated by the frictional heat generated from the dielectric.

The second conductive member 210 may generate heat when power is supplied to heat the aerosol generating article S accommodated in the accommodation space 110a. For example, the second conductive member 210 may be arranged to surround the outer circumference of the aerosol generating article S accommodated in the accommodation space 110a, and generate heat when power is supplied from the battery 600 to heat the aerosol generating article S.

Vapor generated when the aerosol generating article S is heated by the first conductive member 200 or the second conductive member 210 may be mixed with external air introduced into the accommodation space 110a through a gap or an airflow path (not shown) between the accommodation space 110a and the aerosol generating article S, and as a result, aerosols may be generated in the accommodation space 110a.

Referring to FIG. 4, the first conductive member 200 and/or the second conductive member 210 according to an embodiment may include a conductive pattern.

For example, the first conductive member 200 may surround an outer circumference of the accommodation space 110a and include the conductive pattern having a first end portion 200a and a second end portion 200b distinguished from each other. For example, the first conductive member 200 may include the conductive pattern in which the first end portion 200a and the second end portion 200b are not connected to each other and are distinguished from each other. The first end portion 200a and the second end portion 200b of the first conductive member 200 may each be electrically connected to the source unit 120 and/or the ground (not shown) through an electrical connection member (not shown), and the first conductive member 200 may operate as an antenna radiating electromagnetic waves based on the RF signal supplied from the source unit 120, through an electrical connection structure described above. The first conductive member 200 may be formed to have an electrical length capable of radiating electromagnetic waves in a frequency band of about 300 MHz to about 300 GHz, but a shape or electrical length of the first conductive member 200 is not limited thereto.

In another example, the second conductive member 210 may be arranged to surround the first conductive member 200 and the outer circumference of the accommodation space 110a in a radius direction of the first conductive member 200, and include the conductive pattern having a third end portion 210a and a fourth end portion 210b distinguished from each other. For example, the second conductive member 210 may include the conductive pattern in which the third end portion 210a and the fourth end portion 210b are not connected to each other and are distinguished from each other. The third end portion 210a and the fourth end portion 210b of the second conductive member 210 may each be electrically connected to the battery 600 through an electrical connection member, and an electrical path may be formed between the second conductive member 210 and the battery 600 through an electrical connection structure described above. The second conductive member 210 may include the conductive pattern including an electric resistor generating heat when power is supplied, and operate as a heater configured to heat the aerosol generating article S, based on power supplied from the battery 600.

In an embodiment, the aerosol generating device 100 may further include the support 220, the insulator 300, and the fixing member 400, which support the first conductive member 200 and/or the second conductive member 210 and insulate heat generated from the first conductive member 200 and/or the second conductive member 210.

The support 220 may support the first conductive member 200 and/or the second conductive member 210, inside the housing 110. For example, the support 220 may be formed in the shape of a tube as shown in FIG. 4 to surround outer circumferences of the first conductive member 200 and/or the second conductive member 210, and fix positions of the first conductive member 200 and/or the second conductive member 210 through an arrangement structure described above. In other words, the first conductive member 200, the second conductive member 210, and the support 220 may be arranged in the stated order along the radius direction of the accommodation space 110a, and the support 220 may support the first conductive member 200 and/or the second conductive member 210 through a structure of surrounding the outer circumferences of the first conductive member 200 and/or the second conductive member 210. The support 220 may include a same material (e.g., stainless steel) as the first conductive member 200 and/or the second conductive member 210, but is not limited thereto.

The insulator 300 may insulate heat generated from the first conductive member 200 and/or the second conductive member 210. For example, the insulator 300 may be arranged to surround the first conductive member 200 and/or the second conductive member 210, and prevent heat generated while electromagnetic waves are radiated from the first conductive member 200 or heat generated when power is supplied to the second conductive member 210 from being transferred to the housing 110.

In an embodiment, the insulator 300 may include a double-wall structure to effectively insulate heat generated from the first conductive member 200 and/or the second conductive member 210. For example, the insulator 300 may include an inner wall 301, an outer wall 302, and an insulating region 303 between the inner wall 301 and the outer wall 302.

The inner wall 301 may be spaced apart from an outer surface of the support 220 by a designated distance along a radius direction, and arranged to surround an outer circumference of the support 220. For example, the inner wall 301 may be formed in the shape of a tube to surround the outer circumference of the support 220, but is not limited thereto.

The outer wall 302 may be spaced apart from the inner wall 301, inside the housing 110, and one end and an opposite end of the outer wall 302 may extend towards the inner wall 301 to be connected to the inner wall 301. The insulating region 303 in a vacuum state may be provided in a space between the inner wall 301 and the outer wall 302, and may prevent heat generated from the first conductive member 200 and/or the second conductive member 210 from being transferred to the housing 110 along the radius direction. Here, the vacuum state may include not only a state in which there is no air, but also a state in which air exists at a pressure lower than atmospheric pressure.

In an embodiment, the insulator 300 may be spaced apart from the support 220 by the designated distance so as to increase insulating efficiency. For example, the insulator 300 may be spaced apart from the support 220 along the radius direction of the support 220, and an air gap may be formed between the support 220 and the insulator 300. The air gap, together with the insulating region 303, may prevent heat generated from the first conductive member 200 and/or the second conductive member 210 from being transferred to the housing 110 along the radius direction.

In other words, the aerosol generating device 100 according to an embodiment may doubly insulate heat generated from the first conductive member 200 and/or the second conductive member 210 through the air gap between the support 220 and the insulator 300 and the insulating region 303 of the insulator 300, and as a result, high-temperature heat may be prevented from being transferred to the user, thereby increasing user convenience.

The fixing member 400 may fix the first conductive member 200, the second conductive member 210, the support 220, and the insulator 300, inside the housing 110. For example, the fixing member 400 may include an upper fixing member 410, a side fixing member 420, and a lower fixing member 430.

The upper fixing member 410 may be located above (e.g., the z-axis direction of FIG. 3) the first conductive member 200, the second conductive member 210, the support 220, and the insulator 300, and coupled to regions of the first conductive member 200, the second conductive member 210, the support 220, and the insulator 300 facing the z-axis direction. Here, the upper fixing member 410 may include a through hole through which the aerosol generating article S may penetrate, and at least a portion of the aerosol generating article S may pass through the through hole and accommodated inside the accommodation space 110a.

The lower fixing member 430 may be located below (e.g., a-z-axis direction of FIG. 3) the second conductive member 210, the support 220, and the insulator 300, facing the upper fixing member 410, and coupled to regions of the second conductive member 210, the support 220, and the insulator 300 facing the-z-axis direction.

The side fixing member 420 may surround a space between the upper fixing member 410 and the lower fixing member 430, and protect the first conductive member 200, the second conductive member 210, the support 220, and the insulator 300. For example, the side fixing member 420 may be arranged to surround outer circumferences of the first conductive member 200, the second conductive member 210, the support 220, and the insulator 300, and prevent external foreign substances from being introduced to the first conductive member 200, the second conductive member 210, the support 220, and the insulator 300.

Through the above structure, the first conductive member 200, the second conductive member 210, the support 220, and the insulator 300 may have positions fixed inside the housing 110 by the upper fixing member 410, the side fixing member 420, and the lower fixing member 430, and may be protected from introduction of external foreign substances.

The sensor 500 may be located inside the housing 110 and obtain pieces of data for detecting a type of the aerosol generating article S accommodated in the accommodation space 110a. For example, the sensor 500 (or a cigarette identification sensor) may include at least one of a capacitive sensor, an inductive sensor, an optical sensor, and a color sensor for detecting a type of the aerosol generating article S, but a type of the sensor 500 is not limited thereto. In an embodiment, the sensor 500 may be arranged in a region adjacent to the accommodation space 110a and obtain pieces of data according to a type of the aerosol generating article S accommodated in the accommodation space 110a, but an arrangement structure of the sensor 500 is not limited thereto. The pieces of data obtained by the sensor 500 may be transmitted to the processor 610.

In an embodiment, the sensor 500 may be spaced apart from the first conductive member 200 by a certain distance. For example, the sensor 500 may be arranged in one region (or an upper region) adjacent to an insertion hole of the accommodation space 110a of the housing 110, and spaced apart from the first conductive member 200 by a certain distance. When the sensor 500 is adjacent to the first conductive member 200, noise may occur in a detection result of the sensor 500 due to electromagnetic waves radiated from the first conductive member 200. The aerosol generating device 100 according to an embodiment may prevent detection performance deterioration of the sensor 500 caused by electromagnetic waves, through a structure in which the sensor 500 is spaced apart from the first conductive member 200 by a certain distance.

The battery 600 may supply power required for operations of the aerosol generating device 100. The battery 600 may be substantially the same as or similar to the power supply 13 of FIG. 1, and redundant descriptions thereof are omitted below.

For example, the battery 600 may supply power required for the source unit 120 to generate an RF signal and amplify the generated RF signal. In another example, the battery 600 may supply power to the second conductive member 210 so that the second conductive member 210 may generate heat. In another example, the battery 600 may supply power required for operations of the processor 610.

The processor 610 may control general operations of the aerosol generating device 100. The processor 610 may be substantially the same as or similar to the control unit 10 of FIG. 1, and redundant descriptions thereof are omitted below.

In an embodiment, the processor 610 may control power supply of the battery 600 such that a type of the aerosol generating article S accommodated in the accommodation space 110a is detected based on the pieces of data transmitted from the sensor 500, and the aerosol generating article S is heated by selectively using the dielectric heating method or the resistance heating method according to the detected type of the aerosol generating article S.

For example, when it is determined that a first aerosol generating article is accommodated in the accommodation space 110a, the processor 610 may supply power to the source unit 120 through the battery 600 such that the aerosol generating device 100 operates in the first mode to heat the first aerosol generating article by using the dielectric heating method. In another example, when it is determined that a second aerosol generating article different from the first aerosol generating article is accommodated in the accommodation space 110a, the processor 610 may supply power to the second conductive member 210 through the battery 600 such that the aerosol generating device 100 operates in the second mode to heat the second aerosol generating article by using the resistance heating method.

In another embodiment, the aerosol generating device 100 may not include the sensor 500 configured to detect a type of the aerosol generating article S. In this case, the processor 610 may detect a type of the aerosol generating article S accommodated in the accommodation space 110a through the first conductive member 200, and control the battery 600 to supply power to the source unit 120 or the second conductive member 210, based on a result of the detection.

When electromagnetic waves are radiated from the first conductive member 200, reflected waves of the electromagnetic waves, received through the first conductive member 200, may vary depending on a type of the aerosol generating article S accommodated in the accommodation space 110a. For example, when the first aerosol generating article is accommodated in the accommodation space 110a, first reflected waves may be received by the first conductive member 200, and when the second aerosol generating article is accommodated in the accommodation space 110a, second reflected waves different from the first reflected waves may be received by the first conductive member 200.

The processor 610 may compare characteristics (e.g., amplitude) of received reflected waves of electromagnetic waves with pre-stored data related to characteristics of reflected waves according to a type of the aerosol generating article S to detect a type of the aerosol generating article S accommodated in the accommodation space 110a, and control power supply of the battery 600 based on a result of the detection.

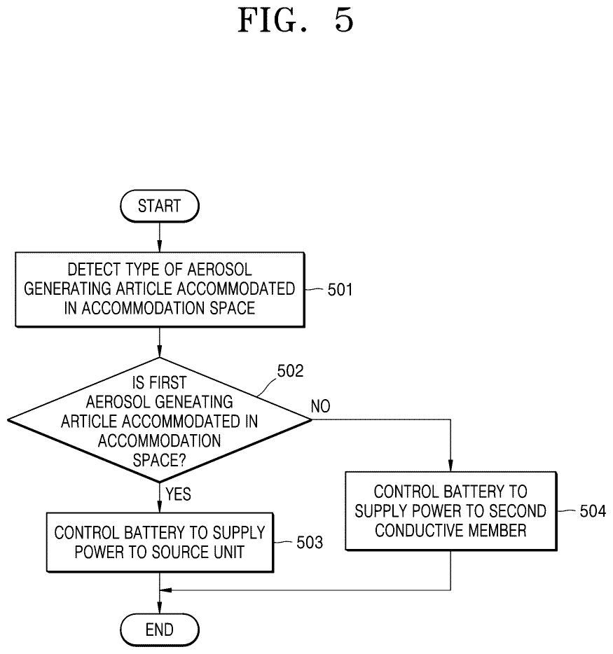

Hereinafter, operations in which the processor 610 controls power supply of the battery 600 according to a type of the aerosol generating article S will be described in detail with reference to FIG. 5.

FIG. 5 is a flowchart for describing an operation of controlling power supply depending on a type of an aerosol generating article accommodated in an aerosol generating device, according to an embodiment. Hereinafter, the components of the aerosol generating device 100 of FIG. 3 will be referenced while describing the operations of FIG. 5 of controlling power supply.

Referring to FIG. 5, in operation 501, the aerosol generating device 100 (e.g., the aerosol generating device 100 of FIG. 3) may detect a type of the aerosol generating article S accommodated in the accommodation space 110a (e.g., the accommodation space 110a of FIG. 3) of the housing 110 (e.g., the housing 110 of FIG. 3).

In an embodiment, the aerosol generating device 100 may detect a type of the aerosol generating article S accommodated in the accommodation space 110a, based on the pieces of data detected through the sensor 500 (e.g., the sensor 500 of FIG. 3). For example, the processor 610 (e.g., the processor 610 of FIG. 3) of the aerosol generating device 100 may detect a type of the aerosol generating article S accommodated in the accommodation space 110a, based on the pieces of data transmitted from the sensor 500.

In another embodiment, the aerosol generating device 100 may detect a type of the aerosol generating article S accommodated in the accommodation space 110a, based on reflected waves of electromagnetic waves, reflected by the aerosol generating article S, the reflected waves received through the first conductive member 200.

After the electromagnetic waves are radiated from the first conductive member 200, some of the electromagnetic waves may be reflected by the aerosol generating article S. At this time, the reflected waves may vary depending on a type of the aerosol generating article S, and the first conductive member 200 operating as an antenna may receive different reflected waves depending on a type of the aerosol generating article S accommodated in the accommodation space 110a.

The processor 610 may detect a type of the aerosol generating article S accommodated in the accommodation space 110a by comparing characteristics (e.g., amplitude) of the reflected waves of the electromagnetic waves, received through the first conductive member 200, with pre-stored data related to characteristics of reflected waves according to a type of the aerosol generating article S, but a method of detecting a type of the aerosol generating article S is not limited thereto.

In operation 502, the aerosol generating device 100 may determine whether the first aerosol generating article is accommodated in the accommodation space 110a, based on a result of performing operation 501. For example, the processor 610 may detect a type of the aerosol generating article S through operation 501 and determine whether the detected type of the aerosol generating article S corresponds to a pre-designated first aerosol generating article. In the disclosure, the first aerosol generating article may refer to an aerosol generating article having a composition that provides optimal smoking sensation when heated by using the dielectric heating method, and the second aerosol generating article may refer to an aerosol generating article having a composition that provides optimal smoking sensation when heated by using the resistance heating method. A type of the aerosol generating article S that may be used in the aerosol generating device 100 according to an embodiment is not limited thereto, and a third aerosol generating article, a fourth aerosol generating article, and the like may be used according to an embodiment.

When it is determined that the first aerosol generating article is accommodated in the accommodation space 110a in operation 502, the aerosol generating device 100 may control the battery 600 to supply power to the source unit 120 so as to be operated in the first mode (or the dielectric heating mode), in operation 503. For example, the processor 610 may supply power to the source unit 120 through the battery 600 so that the first aerosol generating article may be heated by using the dielectric heating method according to the electromagnetic waves radiated from the first conductive member 200. The source unit 120 may transmit, to the first conductive member 200, the RF signal amplified based on power supplied from the battery 600, and the first conductive member 200 may heat the first aerosol generating article by using the dielectric heating method, by radiating the electromagnetic waves based on the transmitted RF signal.

On the other hand, when it is determined that the first aerosol generating article is not accommodated in the accommodation space 110a in operation 502, the aerosol generating device 100 may determine that the second aerosol generating article is accommodated and control the battery 600 to supply power to the second conductive member 210 so as to be operated in the second mode (or the resistance heating mode). For example, when it is determined that the second aerosol generating article is accommodated in the accommodation space 110a, the processor 610 may supply power to the second conductive member 210 through the battery 600 so that the second aerosol generating article is heated by heat generated in the second conductive member 210.

A heating temperature may vary depending on a heating method of the aerosol generating article S, and an optimal heating temperature may vary depending on a type of the aerosol generating article S. The aerosol generating device 100 according to an embodiment may heat the aerosol generating article S by selectively using the dielectric heating method or the resistance heating method according to a type of the aerosol generating article S through operations 501 to 504, thereby improving smoking sensation of the user.

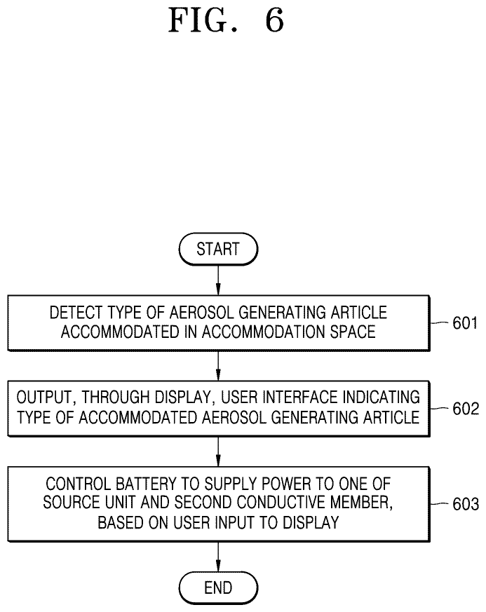

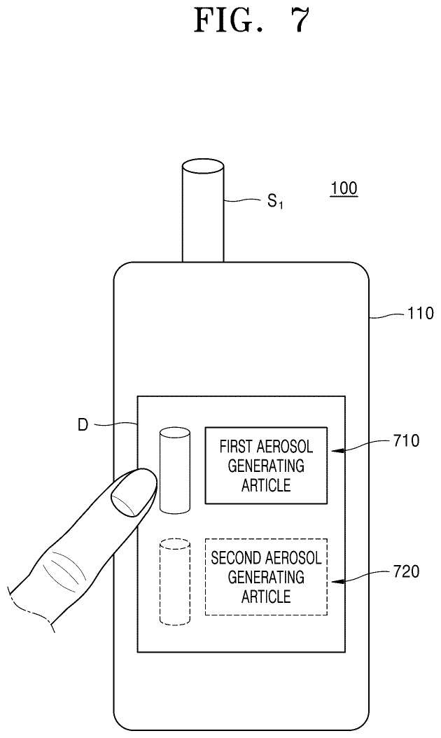

FIG. 6 is a flowchart for describing an operation of controlling power supply based on a user's input on a display of an aerosol generating device, according to another embodiment, and FIG. 7 is a diagram showing a user interface output on a display of an aerosol generating device, according to another embodiment. Hereinafter, components of the aerosol generating device 100 of FIG. 7 will be referenced while describing the operation of FIG. 6 of controlling power supply.

The aerosol generating device 100 according to another embodiment may be a device in which a display D having at least a portion exposed to the outside of the housing 110 and capable of outputting visual information is added to the aerosol generating device 100 of FIG. 3. A processor (e.g., the processor 610 of FIG. 3) may be electrically or operatively connected to the display D, and control visual information output on the display D or control an operation of the aerosol generating device 100, based on a user input to the display D.

Referring to FIGS. 6 and 7, in operation 601, the aerosol generating device 100 according to another embodiment (e.g., the aerosol generating device 100 of FIG. 3 or 7) may detect a type of an aerosol generating article accommodated in an accommodation space (e.g., the accommodation space 110a of FIG. 3) of the housing 110. Operation 601 may be substantially the same as or similar to operation 501 of FIG. 5, and redundant descriptions thereof are omitted below.

In operation 602, the aerosol generating device 100 according to another embodiment may output, through the display D, a user interface indicating the type of the aerosol generating article accommodated in the accommodation space, detected in operation 601. The user interface may include at least one object corresponding to the type of aerosol generating article accommodated in the accommodation space. For example, the user interface may include a first object 710 indicating that a first aerosol generating article S₁ has been accommodated, and a second object 720 indicating that a second aerosol generating article different from the first aerosol generating article S₁ has been accommodated.

For example, when it is determined that the first aerosol generating article S₁ is accommodated in the accommodation space, the processor may output the user interface in which the first object 710 is darker than the second object 720 as shown in FIG. 7 to provide, to the user, a visual notification indicating that the first aerosol generating article S₁ is accommodated in the accommodation space. In another example, when it is determined that the second aerosol generating article different from the first aerosol generating article S₁ is accommodated in the accommodation space, the processor may output the user interface in which the second object 720 is darker than the first object 710 to provide, to the user, a visual notification indicating that the second aerosol generating article is accommodated in the accommodation space.

The user interface output on the display D is not limited thereto, and a form or method of outputting the user interface may vary according to an embodiment as long as a type of an aerosol generating article accommodated in the accommodation space is notified.

In operation 603, the aerosol generating device 100 according to another embodiment may control a battery (e.g., the battery 600 of FIG. 3) to supply power to one of a source unit (e.g., the source unit 120 of FIG. 3) or a second conductive member (e.g., the second conductive member 210 of FIG. 3), based on a user input to the display D. In the disclosure, the user input may include a touch input in which a body part (e.g., a finger) of the user comes into contact with the display D and/or a hovering input in which a body part of the user approaches the display D, but is not limited thereto.

For example, when the user input to the first object 710 output on the display D is received as shown in FIG. 7, the processor of the aerosol generating device 100 may determine that the first aerosol generating article S₁ to be heated by using the dielectric heating method is accommodated and operate the aerosol generating device 100 in the first mode. For example, the processor may supply power to the source unit through the battery so that the aerosol generating device 100 may operate in the first mode. The source unit may generate an RF signal based on power supplied from the battery and transmit the RF signal to a first conductive member (e.g., the first conductive member 200 of FIG. 3), and the first conductive member may radiate electromagnetic waves based on the RF signal transmitted from the source unit to heat the first aerosol generating article S₁ by using the dielectric heating method.

In FIG. 7, only an embodiment in which power is supplied to the source unit through the battery, based on the user input to the first object 710, while the first aerosol generating article S₁ is accommodated is illustrated, but the disclosure is not limited thereto.

In another embodiment, the second aerosol generating article may be accommodated in the accommodation space, and in this case, the processor may output, through the display D, an interface for providing visual information indicating that the second aerosol generating article has been accommodated. When a user input to the second object 720 output on the display D is received, the processor may determine that the second aerosol generating article to be heated by using the resistance heating method is accommodated and operate the aerosol generating device 100 in the second mode. For example, the processor may supply power to the second conductive member through the battery so that the aerosol generating device 100 may operate in the second mode. When power is supplied from the battery, the second conductive member may generate heat, and the second aerosol generating article may be heated through heat generated from the second conductive member.

Through operations 601 to 603, the aerosol generating device 100 according to another embodiment may provide, through the display D, the user with visual information about a type of an aerosol generating article accommodated in the accommodation space, and heat the aerosol generating article by selectively using the dielectric heating method or the resistance heating method, based on a user input. In other words, the aerosol generating device 100 according to another embodiment may provide the user with a choice of a heating method according to a type of an aerosol generating article and heat the aerosol generating article by using the dielectric heating method or the resistance heating method, based on selection of the user, thereby improving smoking sensation of the user.

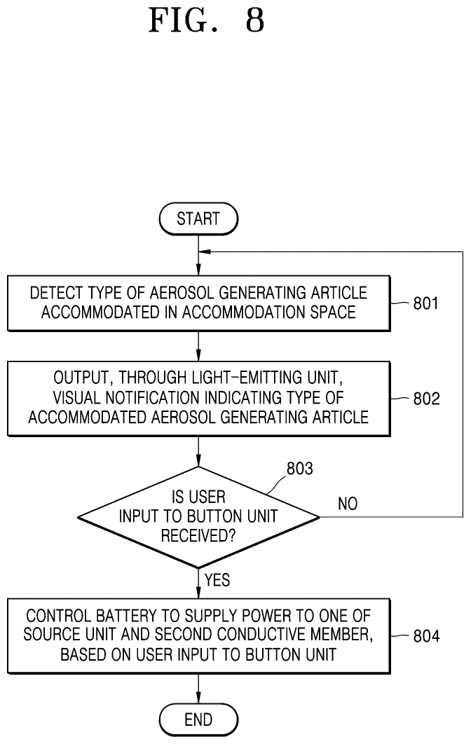

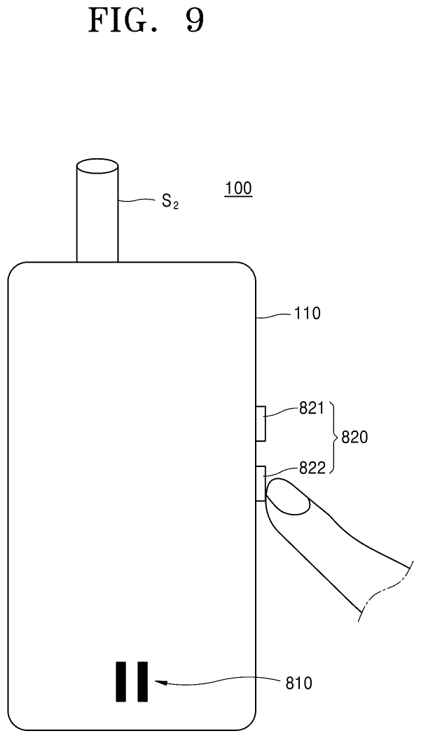

FIG. 8 is a flowchart for describing an operation of controlling power supply based on a user's input on a button unit of an aerosol generating device, according to another embodiment, and FIG. 9 is a diagram showing a light-emitting unit of an aerosol generating device, according to another embodiment.

Hereinafter, components of the aerosol generating device 100 of FIG. 9 will be referenced while describing the operation of FIG. 8 of controlling power supply.

The aerosol generating device 100 according to another embodiment may be the aerosol generating device 100 of FIG. 3 further including a light-emitting unit 810 and at least one button unit 820. The processor may be electrically or operatively connected to the light-emitting unit 810 and the at least one button unit 820, and control operations of the aerosol generating device 100, based on an operation of the light-emitting unit 810 and/or a user input to the at least one button unit 820. For example, the light-emitting unit 810 may include at least one light-emitting diode (LED), and the at least one button unit 820 may include a first button unit 821 and a second button unit 822, but an embodiment is not limited thereto.

Referring to FIGS. 8 and 9, in operation 801, the aerosol generating device 100 according to another embodiment (e.g., the aerosol generating device 100 of FIG. 3 or 9) may detect a type of an aerosol generating article accommodated in an accommodation space (e.g., the accommodation space 110a of FIG. 3) of the housing 110. Operation 801 may be substantially the same as or similar to operation 501 of FIG. 5, and redundant descriptions thereof are omitted below.

In operation 802, the aerosol generating device 100 according to another embodiment may output, through the light-emitting unit 810, a visual notification indicating the type of the aerosol generating article accommodated in the accommodation space, detected in operation 801. For example, the light-emitting unit 810 may include two LEDs, and the processor may control the light-emitting unit 810 to emit light from one LED when it is determined that a first aerosol generating article is accommodated in the accommodation space. In another example, the processor may control the light-emitting unit 810 to emit light from both LEDs when it is determined that a second aerosol generating article S₂ is accommodated in the accommodation space. A method of outputting the visual notification is not limited thereto, and according to an embodiment, the visual notification may be provided by emitting light from one LED (e.g., a left LED) when the first aerosol generating article is accommodated and emitting light from another LED (e.g., a right LED) when the second aerosol generating article S₂ is accommodated.

In operation 803, the aerosol generating device 100 according to another embodiment may determine whether a user input to the at least one button unit 820 is received. For example, the processor may be electrically or operatively connected to the first button unit 821 and the second button unit 822, and determine whether the user input to the first button unit 821 or the second button unit 822 is received.

When it is determined that the user input to the at least one button unit 820 is received in operation 803, the aerosol generating device 100 according to another embodiment may control a battery (e.g., the battery 600 of FIG. 3) to supply power to one of a source unit (e.g., the source unit 120 of FIG. 3) and a second conductive member (e.g., the second conductive member 210 of FIG. 3), based on the user input to the at least one button unit 820, in operation 804.

For example, when a user input to the first button unit 821 is received, the processor of the aerosol generating device 100 may determine that the first aerosol generating article to be heated by using the dielectric heating method is accommodated and operate the aerosol generating device 100 in the first mode. For example, the processor may supply power to the source unit through the battery so that the aerosol generating device 100 may operate in the first mode. The source unit may generate an RF signal based on power supplied from the battery and transmit the RF signal to a first conductive member (e.g., the first conductive member 200 of FIG. 3), and the first conductive member may radiate electromagnetic waves based on the RF signal transmitted from the source unit to heat the first aerosol generating article by using the dielectric heating method.

In another example, when a user input to the second button unit 822 is received as shown in FIG. 9, the processor may determine that the second aerosol generating article S₂ to be heated by using the resistance heating method is accommodated and operate the aerosol generating device 100 in the second mode. For example, the processor may supply power to the second conductive member through the battery so that the aerosol generating device 100 may operate in the second mode. When power is supplied from the battery, the second conductive member may generate heat, and the second aerosol generating article S₂ may be heated through heat generated from the second conductive member.

On the other hand, when it is determined that the user input to the at least one button unit 820 is not received in operation 803, the aerosol generating device 100 according to another embodiment may determine that the user does not have a smoking intention and repeat operations 801 to 803.

Through operations 801 to 804, the aerosol generating device 100 according to another embodiment may provide, through the light-emitting unit 810, the user with visual information about a type of an aerosol generating article accommodated in the accommodation space, and heat the aerosol generating article by selectively using the dielectric heating method or the resistance heating method, based on the user input to the at least one button unit 820. In other words, the aerosol generating device 100 according to another embodiment may provide the user with a choice of a heating method according to a type of an aerosol generating article and heat the aerosol generating article by using the dielectric heating method or the resistance heating method, based on selection of the user.

An aerosol generating device according to an embodiment includes a housing including an accommodation space for accommodating an aerosol generating article, a battery arranged inside the housing, a source unit arranged inside the housing and configured to generate electromagnetic waves based on power supplied from the battery, a first conductive member arranged to surround at least a portion of the aerosol generating article accommodated in the accommodation space and configured to radiate the electromagnetic waves generated in the source unit towards the aerosol generating article to heat the aerosol generating article, a second conductive member arranged to surround at least a portion of the aerosol generating article accommodated in the accommodation space and configured to generate heat when power is supplied from the battery to heat the aerosol generating article, and a processor operatively connected to the battery, wherein the processor is configured to control the battery to supply power to one of the source unit and the second conductive member, based on a type of the aerosol generating article accommodated in the accommodation space.

For example, the source unit may be configured to generate a radio frequency (RF) signal according to the supply of power from the battery, and amplify the generated RF signal, and the first conductive member may be configured to radiate the electromagnetic waves when the RF signal is transmitted from the source unit.

For example, the first conductive member may be further configured to radiate the electromagnetic waves to vibrate a dielectric included in the aerosol generating article, and heat the aerosol generating article through frictional heat generated in the dielectric.

In an embodiment, the aerosol generating device may further include a sensor configured to detect the type of the aerosol generating article accommodated in the accommodation space, wherein the processor may be operatively connected to the sensor and further configured to detect the type of the aerosol generating article accommodated in the accommodation space through the sensor.

For example, the processor may be further configured to, when a first aerosol generating article is accommodated in the accommodation space, supply power to the source unit through the battery to heat the first aerosol generating article through the first conductive member, and when a second aerosol generating article is accommodated in the accommodation space, supply power to the second conductive member through the battery to heat the second aerosol generating article through the second conductive member.

In another embodiment, the aerosol generating device may further include a display outputting a user interface indicating the type of the aerosol generating article accommodated in the accommodation space, wherein the processor may be further configured to control the battery to supply power to one of the source unit and the second conductive member, based on a user input to the display.

For example, the user interface may include a first object indicating that a first aerosol generating article has been accommodated in the accommodation space, and a second object indicating that a second aerosol generating article different from the first aerosol generating article has been accommodated in the accommodation space.

For example, the processor may be further configured to supply power to the source unit through the battery, based on a user input to the first object, to heat the first aerosol generating article through the first conductive member, and supply power to the second conductive member through the battery, based on a user input to the second object, to heat the second aerosol generating article through the second conductive member.

In another embodiment, the aerosol generating device may further include a light-emitting unit configured to provide a visual notification about the type of the aerosol generating article accommodated in the accommodation space, and at least one button unit configured to receive a user input, wherein the processor may be further configured to control the battery, based on the user input to the at least one button unit, to supply power to one of the source unit and the second conductive member.

In another embodiment, the processor may be further configured to receive reflected waves of the electromagnetic waves radiated towards the aerosol generating article through the first conductive member, and detect the type of the aerosol generating article accommodated in the accommodation space, based on the received reflected waves.

In an embodiment, the first conductive member and the second conductive member may each have patterns including one end portion and another end portion.

In this case, the second conductive member may be arranged to surround at least a portion of an outer circumference of the first conductive member.

In an embodiment, the aerosol generating device may further include a support arranged to surround at least a portion of an outer circumference of the second conductive member, inside the housing, and configured to support the second conductive member.

The aerosol generating device may further include an insulator including an inner wall spaced apart from an outer surface of the support by a designated distance and surrounding an outer circumference of the support, an outer wall spaced apart from the inner wall, and an insulating region in a vacuum state between the inner wall and the outer wall.

The aerosol generating device may further include an air gap between the support and the insulator and configured to insulate heat generated from the first conductive member or the second conductive member.

Some embodiments or other embodiments of the disclosure described above are not exclusive or distinct from each other. In some embodiments or other embodiments of the disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

An aerosol generating device according to embodiments may provide an improved smoking sensation to a user by varying a heating method depending on a type of an aerosol generating article.

However, effects of the embodiments are not limited to the above-described effects, and effects not mentioned may be clearly understood by one of ordinary skill in the art to which the embodiments

What is claimed is:

1. An aerosol generating device comprising:
a housing including an accommodation space for accommodating an aerosol generating article;
a battery arranged inside the housing;
a source unit arranged inside the housing and configured to generate electromagnetic waves based on power supplied from the battery;
a first conductive member arranged to surround at least a portion of the aerosol generating article accommodated in the accommodation space and configured to radiate the electromagnetic waves generated in the source unit towards the aerosol generating article to heat the aerosol generating article;
a second conductive member arranged to surround at least a portion of the aerosol generating article accommodated in the accommodation space and configured to generate heat when power is supplied from the battery to heat the aerosol generating article; and
a processor operatively connected to the battery,
wherein the processor is configured to control the battery to supply power to one of the source unit and the second conductive member, based on a type of the aerosol generating article accommodated in the accommodation space.

2. The aerosol generating device of claim 1, wherein the source unit is configured to generate a radio frequency (RF) signal according to the supply of power from the battery, and amplify the generated RF signal, and
the first conductive member is configured to radiate the electromagnetic waves when the RF signal is transmitted from the source unit.

3. The aerosol generating device of claim 1, wherein the first conductive member is further configured to radiate the electromagnetic waves to vibrate a dielectric included in the aerosol generating article and heat the aerosol generating article through frictional heat generated in the dielectric.

4. The aerosol generating device of claim 1, further comprising a sensor configured to detect the type of the aerosol generating article accommodated in the accommodation space,
wherein the processor is operatively connected to the sensor and is further configured to detect the type of the aerosol generating article accommodated in the accommodation space through the sensor.

5. The aerosol generating device of claim 4, wherein the processor is further configured to:
when a first aerosol generating article is accommodated in the accommodation space, supply power to the source unit through the battery to heat the first aerosol generating article through the first conductive member; and
when a second aerosol generating article is accommodated in the accommodation space, supply power to the second conductive member through the battery to heat the second aerosol generating article through the second conductive member.

6. The aerosol generating device of claim 4, further comprising a display outputting a user interface indicating the type of the aerosol generating article accommodated in the accommodation space,
wherein the processor is further configured to control the battery to supply power to one of the source unit and the second conductive member, based on a user input to the display.

7. The aerosol generating device of claim 6, wherein the user interface comprises:
a first object indicating that a first aerosol generating article has been accommodated in the accommodation space; and
a second object indicating that a second aerosol generating article different from the first aerosol generating article has been accommodated in the accommodation space.

8. The aerosol generating device of claim 7, wherein the processor is further configured to:
supply power to the source unit through the battery, based on a user input to the first object, to heat the first aerosol generating article through the first conductive member; and
supply power to the second conductive member through the battery, based on a user input to the second object, to heat the second aerosol generating article through the second conductive member.

9. The aerosol generating device of claim 4, further comprising:
a light-emitting unit configured to provide a visual notification about the type of the aerosol generating article accommodated in the accommodation space; and
at least one button unit configured to receive a user input,
wherein the processor is further configured to control the battery, based on the user input to the at least one button unit, to supply power to one of the source unit and the second conductive member.

10. The aerosol generating device of claim 1, wherein the processor is further configured to:
receive reflected waves of the electromagnetic waves radiated towards the aerosol generating article through the first conductive member; and
detect the type of the aerosol generating article accommodated in the accommodation space, based on the received reflected waves.

11. The aerosol generating device of claim 1, wherein the first conductive member and the second conductive member each have patterns including one end portion and another end portion.

12. The aerosol generating device of claim 1, wherein the second conductive member is arranged to surround at least a portion of an outer circumference of the first conductive member.

13. The aerosol generating device of claim 12, further comprising a support arranged to surround at least a portion of an outer circumference of the second conductive member inside the housing and configured to support the second conductive member.

14. The aerosol generating device of claim 13, further comprising an insulator including an inner wall spaced apart from an outer surface of the support by a designated distance and surrounding an outer circumference of the support, an outer wall spaced apart from the inner wall, and an insulating region in a vacuum state between the inner wall and the outer wall.

15. The aerosol generating device of claim 14, further comprising an air gap between the support and the insulator and configured to insulate heat generated from the first conductive member or the second conductive member.
